(19) United States
(12) Patent Application Publication
(10) Pub. No.: US 2003/0081665 A1
(43) Pub. Date: May 1, 2003

(54) Electronic apparatus with internal modems

(75) Inventor: Tsutoo Tokairin, Yonezawa-shi (JP)

Correspondence Address: YOUNG & THOMPSON, 745 SOUTH 23RD STREET 2ND FLOOR, ARLINGTON, VA, 22202

(73) Assignee: NEC CORPORATION, Tokyo (JP)

(21) Appl. No.: 10/273,811

(22) Filed: Oct. 22, 2002

(30) Foreign Application Priority Data
Nov. 1, 2001 (JP) 2001-336776

(51) Int. Cl. H04B 1/38; H04L 5/16

(52) U.S. Cl. 375/222

(57) ABSTRACT

An electronic apparatus reduces attachment space occupied by a modem connector and prevents the user from erroneously inserting a modem connector to a non-corresponding connector (jack). The electronic apparatus includes a plurality of modems, an input port connected to a communication line and a switch connected to the plurality of modems and the input port. The input port outputs a signal from the communication line, and the switch outputs the signal to a selected one of the plurality of modems.

### BACKGROUND OF THE INVENTION

The present invention relates to an electronic apparatus such as a personal computer with internal modems, and more particularly, to an electronic apparatus with an Asymmetric Digital Subscriber Line (ADSL) modem and a normal analog modem using for example, a 56K dial-up access.

Nowadays, ADSL is increasingly popular as a communication line. Consequently, current electronic apparatus tends to have an ADSL modem in addition to a normal analog modem.

A conventional personal computer having an ADSL modem and a normal analog modem will first be explained. Referring to FIG. 3, the conventional personal computer 100 includes a Peripheral Component Interconnect (PCI) bus 1, a normal analog modem 2, an ADSL modem 3, a connector (jack) 4, a connector (jack) 5 and a casing 8. The normal analog modem 2 and the ADSL modem 3 are connected to the PCI bus 1. The casing 8 incorporates the analog modem 2 and the ADSL modem 3. The connector (jack) 4 and the connector (jack) 5 are attached to a surface of the casing 8 and are connected to a telephone line by inserting a connector (pin) 9 of a telephone line cable 7.

The two connectors (jacks) 4 and 5 are separately provided on the casing 8 so that analog signal m from the telephone line, inputted to the normal analog modem 2, is inputted via the connector (jack) 5, whereas the analog signal n from the telephone line, inputted to the ADSL modem 3, is inputted via the connector (jack) 4.

When a user uses a normal connection such as a 56K dial-up access, the user connects the connector (pin) 9 to the connector (jack) 5. On the other hand, when the user uses an ADSL connection, the user connects the connector (pin) 9 to the connector (jack) 4.

It should be noted that the connector 4 and connector 5 are the same shape and have the same function. Nevertheless, the PC 100 has two connectors. That means the PC 100 wastes attachment space. This drawback is more pronounced when the PC 100 is a notebook type, because attachment space allowed by a notebook PC is more limited than a desktop PC. Moreover, there is a possibility that the user erroneously inserts the connector (pin) in a non-corresponding connector (jack).

### SUMMARY OF THE INVENTION

Thus, the present invention has an object to provide an electronic apparatus which reduces attachment space occupied by a connector (jack) and prevents the user from erroneously inserting a connector (pin) to a non-corresponding connector (jack).

According to the present invention, an electronic apparatus with internal modems includes a plurality of modems, an input port connected to a communication line, and a switch connecting the plurality of modems to the input port. The input port outputs a signal from the communication line and the switch outputs the signal to a selected one of the plurality of modems.

### BRIEF DESCRIPTION OF THE DRAWINGS

These and other objects, features and advantages of the invention will become more apparent from the following detailed description when taken in conjunction with the accompanying drawings, in which:

FIG. 1 is a block diagram schematically showing a personal computer with internal modems according to a first embodiment of the present invention;

FIG. 2 is a block diagram schematically showing a personal computer with internal modems according to a second embodiment of the present invention; and

FIG. 3 is a block diagram schematically showing a conventional personal computer with internal modems.

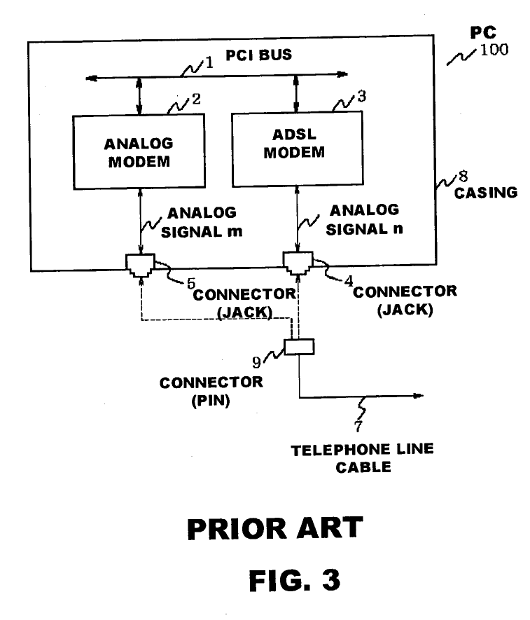

### DESCRIPTION OF THE PREFERRED EMBODIMENTS

The present invention will be now explained in detail below in reference to the accompanying drawings.

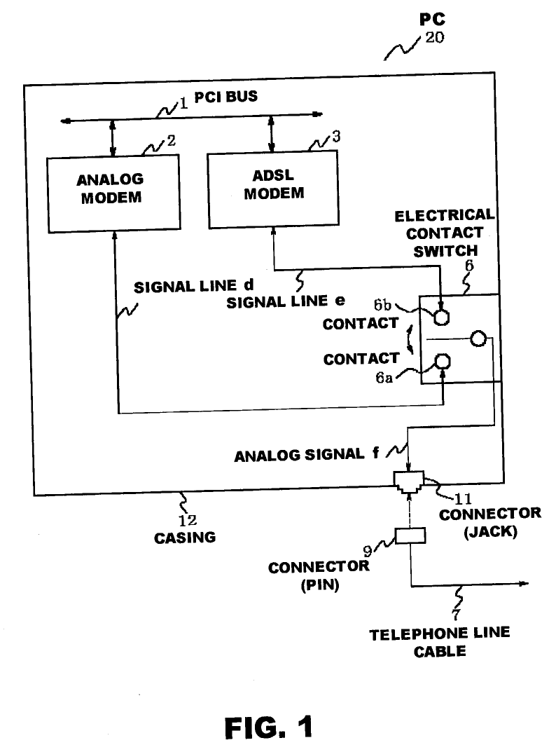

Referring to FIG. 1, a personal computer 20 includes a PCI bus 1, a normal analog modem 2 using a 56K dial-up access, an ADSL modem 3, an electrical contact switch 6, a connector (jack) 11 and a casing 12. The normal analog modem 2 and the ADSL modem 3 are connected to the PCI bus 1. The casing 8 incorporates the analog modem 2 and the ADSL modem 3. The connector (jack) 11 is attached to the surface of the casing 12 and is connected to the telephone line by inserting a connector (pin) 9 of a telephone line cable 7. The electrical contact switch 6 is connected to the connector (jack) 11, the analog modem 2, and the ADSL modem 3. Analog signal f from the telephone line is inputted to the analog modem 2 or the ADSL modem 3 by switching by the electrical contact switch 6.

In the personal computer 20, an attachment portion of the connector (jack) 11 is generally limited to one side of the casing 12. However, the electrical contact switch 6 may be located greater freedom and the attachment position is determined depending on the entire available space. Consequently, only a single connector (jack) 11 is used and therefore limited space is conserved.

Next, referring to FIG. 1, the operation of the personal computer 20 according to this embodiment will be explained.

First, a user connects the connector (pin) 9 to the connector (jack) 11. Then, when a user uses a normal connection such as a 56K dial-up access, the user switches the electrical contact switch 6 connected to a contact 6a so that the analog signal f is inputted to the normal analog modem 2 via a signal line d.

On the other hand, when the user uses an ADSL connection, the user switches the electrical contact switch 6 connected to a contact 6b so that the analog signal f is inputted to the ADSL modem 3 via a signal line e.

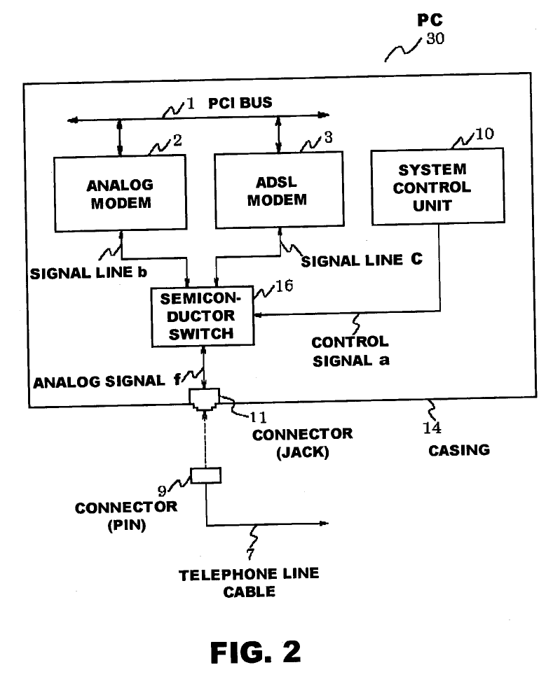

Referring to FIG. 2, in a second embodiment of the present invention, a personal computer 30 includes a PCI bus 1, a normal analog modem 2 using 56K dial-up access, an ADSL modem 3, a system control unit 10, a connector (jack) 11, a casing 14 and a semiconductor switch 16. The normal analog modem 2 and the ADSL modem 3 are connected to the PCI bus. The casing 14 incorporates the normal analog modem 2, the ADSL modem 3, the system control unit 10 and the semiconductor switch 16. The connector (jack) 11 is attached to a surface of the casing 14 and is connected to the telephone line. The semiconductor switch 16 is connected to the analog modem 2, the ADSL modem 3, the system control unit 10 and the connector (jack) 11. The system control unit 10 controls the semiconductor switch 16.

In operation, a user first connects the connector (pin) 9 to the connector (jack) 11. Then, when a user uses a normal connection such as a 56K dial-up access, the user inputs a command from an input unit (not shown) to the system control unit 10 so that the semiconductor switch 16 connects the connector 11 to the normal analog modem 2 by control signal a based on the command. Thus, the analog signal f is inputted to the normal analog modem as signal b.

On the other hand, when the user uses an ADSL connection, the user inputs a command from the input unit (not shown) to the system control unit 10 so that the semiconductor switch 16 connects the connector 11 to the ADSL modem 3 by control signal a based on the command. Thus, the analog signal f is inputted to the ADSL modem as signal c.

As an example of the control signal a, the control operation for using either of the signal b and the signal c is performed by inputting the control signal a from the system control unit 10 to the semiconductor switch 16 comprising a logic Integrated Circuit (IC). If the control signal a is “1” as High, the analog signal f is inputted to the normal analog modem 2 as the signal b. If the control signal a is “0” as Low, the analog signal f is inputted to the ADSL modem 3 as the signal c.

In more detail, the setting of a register (not shown) in the system control unit 10 determines which level is outputted from the system control unit 10. A value of the register is operated by the command inputted by user.

As mentioned above, the personal computers of the present invention need have only a single connector (jack) 11 to which the connector (pin) 9 of the telephone line cable 7 from the telephone line is attached, irrespective of the signal format of the used line being that of ADSL or a normal modem. Therefore, the attachment space occupied by a connector (jack) is minimized. The invention also prevents the user from inserting a connector (pin) to a non-corresponding connector (jack).

While this invention has been described in conjunction with the preferred embodiments described above, it will now be possible for those skilled in the art to put this invention into practice in various other manners.

What is claimed is:

1. An electronic apparatus with internal modems, comprising:
a plurality of modems;
an input port connected to a communication line;
a switch selectively connecting said plurality of modems to said input port;
wherein said input port outputs a signal from said communication line, and said switch outputs said signal to any selected one of said plurality of modems.

2. The electronic apparatus with internal modems as claimed in claim 1, wherein said plurality of modems includes a modem for a Digital Subscriber Line.

3. The electronic apparatus as claimed in claim 1, wherein said plurality of modems includes a modem for a dial-up connection.

4. The electronic apparatus as claimed in claim 1, wherein said plurality of modems includes a modem for a dial-up connection and a modem for a Digital Subscriber Line.

5. An electronic apparatus with internal modems, comprising:
a first modem;
a second modem which has a different signal format than said first modem;
an input port connected to a communication line;
a switch selectively connecting said first and second modems to said input port;
wherein said input port outputs a signal from said communication line, and said switch outputs said signal to a selected one of said first modem or said second modem selectively.

6. The electronic apparatus as claimed in claim 5, wherein said first modem is for a Digital Subscriber Line.

7. The electronic apparatus as claimed in claim 5, wherein said first modem is for a dial-up connection.

8. The electronic apparatus as claimed in claim 5, wherein said first modem is for a Digital Subscriber Line, and said second modem is for a dial-up connection.

9. The electronic apparatus as claimed in claim 8, wherein said switch comprises an electrical contact switch manually actuated by a user.

10. The electronic apparatus as claimed in claim 8, wherein said switch comprises a semiconductor switch electronically actuated by a command from a user.
